(19) United States
(12) Patent Application Publication
(10) Pub. No.: US 2024/0411893 A1
(43) Pub. Date: Dec. 12, 2024

(54) DETERMINATION SYSTEM, DETERMINATION METHOD, AND RECORDING MEDIUM

(71) Applicant: NEC Corporation, Minato-ku, Tokyo (JP)

(72) Inventors: Kazuaki NAKAJIMA, Tokyo (JP); Io FURUYAMA, Tokyo (JP); Hirofumi UEDA, Tokyo (JP)

(73) Assignee: NEC Corporation, Minato-ku, Tokyo (JP)

(21) Appl. No.: 18/701,290

(22) PCT Filed: Nov. 9, 2021
(86) PCT No.: PCT/JP2021/041077

§ 371 Date: Apr. 15, 2024

(51) Int. Cl. G06F 21/57

(52) U.S. Cl. CPC G06F 21/577; G06F 2221/033

(57) ABSTRACT

A determination system according to an aspect of the present disclosure includes: at least one memory storing a set of instructions; and at least one processor configured to execute the set of instructions to: receive a first inspection result that is a result of a first inspection of vulnerability of target software; receive a second inspection result that is a result of a second inspection of vulnerability of the target software; determine validity of the first inspection from undetected vulnerability that is vulnerability detected in the result of the second inspection and not detected in the result of the first inspection; and output a result of determination of the validity.

### TECHNICAL FIELD

The present disclosure relates to a technique for verifying validity of an inspection.

### BACKGROUND ART

With the recent increase in cybercrimes, the importance of ensuring the security of software is increasing.

PTL 1 discloses an example of a software inspection method for inspecting whether software is safe. In the software inspection method of Patent Literature 1, a plurality of pieces of software executed by a first domain are inspected by a second domain that inspects whether the software is safe.

### CITATION LIST

### Patent Literature

PTL 1: WO 2008/096891 A1

### SUMMARY OF INVENTION

### Technical Problem

Even if the vulnerability of the software is inspected, the safety of the software cannot be secured unless the inspection is a valid inspection. In the technique of Patent Literature 1, it is not possible to confirm whether the performed inspection is a valid inspection.

One object of the present disclosure is to provide a determination device and the like that can determine the validity of an inspection of software.

### Solution to Problem

A determination system according to an aspect of the present disclosure includes: first result reception means for receiving a first inspection result that is a result of a first inspection of vulnerability of target software; second result reception means for receiving a second inspection result that is a result of a second inspection of vulnerability of the target software; determination means for determining a validity degree of the first inspection from undetected vulnerability that is vulnerability detected in the result of the second inspection and not detected in the result of the first inspection; and output means for outputting a result of determination of the validity.

A determination method according to an aspect of the present disclosure includes: receiving a first inspection result that is a result of a first inspection for vulnerability of target software; receiving a second inspection result that is a result of a second inspection for vulnerability of the target software; determining validity of the first inspection from an undetected vulnerability that is a vulnerability detected in a result of the second inspection and not detected in a result of the first inspection; and outputting a result of determination of the validity.

A storage medium according to an aspect of the present disclosure stores a program for causing a computer to execute: first result reception processing of receiving a first inspection result that is a result of a first inspection of vulnerability of target software; second result reception processing of receiving a second inspection result that is a result of a second inspection of the vulnerability of the target software; determination processing of determining a validity degree of the first inspection from undetected vulnerability that is the vulnerability detected in the result of the second inspection and not detected in the result of the first inspection; and output processing of outputting the result of the determination of the validity.

reception processing reception processing Advantageous Effects of Invention

The present disclosure has an effect that validity of software inspection can be determined.

### BRIEF DESCRIPTION OF DRAWINGS

FIG. 1 is a block diagram illustrating an example of a configuration of a determination system according to a first example embodiment of the present disclosure.

FIG. 2 is a flowchart illustrating an example of the operation of the determination system according to the first example embodiment of the present disclosure.

FIG. 3 is a block diagram illustrating an example of a configuration of a determination system according to a second example embodiment of the present disclosure.

FIG. 4 is a block diagram illustrating an example of an operation of the determination system according to the second example embodiment of the present disclosure.

FIG. 5 is a diagram illustrating an example of a hardware configuration of a computer that can achieve the determination system according to the example embodiment of the present disclosure.

### EXAMPLE EMBODIMENT

Hereinafter, example embodiments of the present disclosure will be described in detail with reference to the drawings.

### First Example Embodiment

First, a first example embodiment of the present disclosure will be described in detail with reference to the drawings.

### <Configuration>

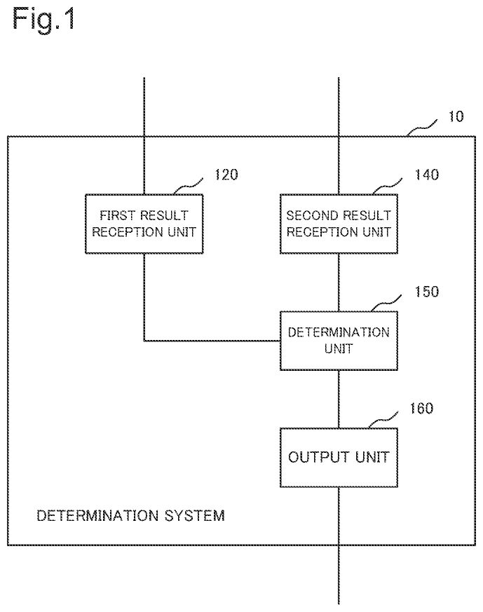

FIG. 1 is a block diagram illustrating an example of a configuration of a determination system according to a first example embodiment of the present disclosure. In the example illustrated in FIG. 1, a determination system 10 of the present example embodiment includes a first result reception unit 120, a second result reception unit 140, a determining unit 150, and an output unit 160. The first result reception unit 120 receives a first inspection result that is a result of a first inspection of the vulnerability of the target software. The second result reception unit 140 receives a second inspection result that is a result of a second inspection of the vulnerability of the target software. The determining unit 150 determines validity of the first inspection from an undetected vulnerability that is a vulnerability detected in the result of the second inspection and not detected in the result of the first inspection. The output unit 160 outputs a result of the validity determination.

The target software is software to be inspected for vulnerability. The first inspection is an inspection of vulnerability performed by an inspection agency. The inspection agency that performs the first inspection is referred to as a first inspection agency. The second inspection is an inspection of vulnerability performed by an inspection agency different from the first inspection agency. The inspection agency that performs the second inspection is referred to as a second inspection agency. The first inspection method and the second inspection method may not be the same method. The criteria for determining the degree of severity (hereinafter described as severity degree) of the vulnerability are the same in the first inspection and the second inspection. The criteria for determining the number of vulnerabilities are the same in the first inspection and the second inspection. The criteria for determining the number of vulnerabilities are the same in the first inspection and the second inspection.

Specifically, the result of the inspection described above indicates information on the result of the inspection. The information on the result of the inspection includes, for example, a date and time of the inspection, a list of vulnerability information detected by the inspection (also referred to as a vulnerability information list), a procedure of intrusion inspection, and the like.

### <First Result Reception Unit 120>

The first result reception unit 120 receives a result of the first inspection of the target software from a first inspection agency (specifically, the information processing device (hereinafter, also referred to as a first device) managed by the first inspection agency) that performs the first inspection. The result of the first inspection is the result of the vulnerability inspection (i.e., the first inspection) of the target software performed by the first inspection agency. The first result reception unit 120 may receive the electronic signature of the result of the first inspection in addition to the result of the first inspection. The electronic signature of the result of the first inspection is electronic data generated by one of a variety of existing methods that proves that the result of the first inspection has been generated by the first inspection agency and not tampered. Specifically, the electronic signature of the result of the first inspection is data generated by encrypting the hash value of the electronic data of the result of the first inspection using a private key of the first inspection agency.

### <Second Result Reception Unit 140>

The second result reception unit 140 receives a result of the second inspection of the target software from a second inspection agency (specifically, the information processing device (hereinafter, also referred to as a second device) managed by the second inspection agency) that performs the second inspection. The result of the second inspection is the result of the vulnerability inspection (i.e., the second inspection) of the target software performed by the second inspection agency. The second result reception unit 140 may receive the electronic signature of the result of the second inspection in addition to the result of the second inspection. The electronic signature of the result of the second inspection is electronic data generated by one of a variety of existing methods that proves that the result of the second inspection has been generated by the second inspection agency and not tampered. Specifically, the electronic signature of the result of the second inspection is data generated by encrypting the hash value of the electronic data of the result of the second inspection using a private key of the second inspection agency.

### <Determining Unit 150>

The determining unit 150 compares the result of the first inspection with the result of the second inspection, and extracts vulnerability (hereinafter described as undetected vulnerability) detected in the result of the second inspection and not detected in the result of the first inspection. The determining unit 150 determines validity of the first inspection from the extracted undetected vulnerability. A specific example of the determination method of the first inspection will be described in detail later.

### <Output Unit 160>

The output unit 160 outputs the result of determination of validity to, for example, a display device or another information processing device. The output unit 160 may output information on the undetected vulnerability (e.g., a severity indicating a degree of severity of the undetected vulnerability, a type of undetected vulnerability, and description of the undetected vulnerability).

### <Operation>

Next, an operation of the determination system according to the first example embodiment of the present disclosure will be described in detail with reference to the drawings.

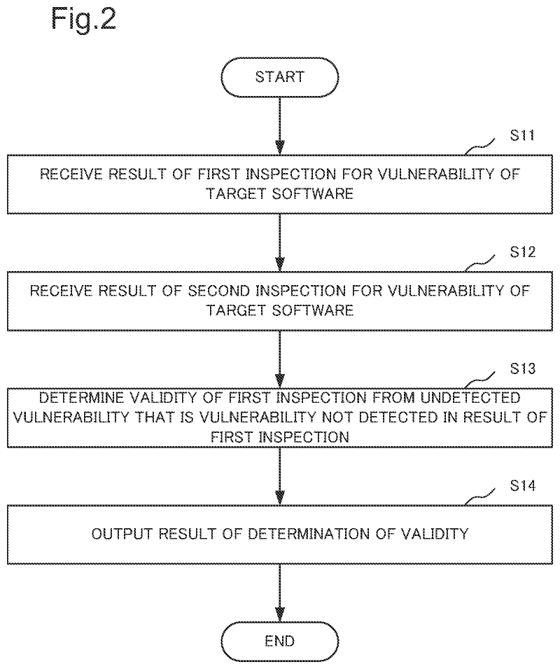

FIG. 2 is a flowchart illustrating an example of the operation of the determination system according to the first example embodiment of the present disclosure. In the example illustrated in FIG. 2, the first result reception unit 120 receives the result of the first inspection on the vulnerability of the target software (step S11). The second result reception unit 140 receives the result of the second inspection on the vulnerability of the target software (step S12). Then, the determining unit 150 determines validity of the first inspection from the undetected vulnerability that is the vulnerability detected in the result of the second inspection and not detected in the result of the first inspection (step S13). The output unit 160 outputs the determination result of validity, that is, the determined validity (step S14).

### Effects

The present disclosure has an effect that validity of software inspection can be determined. This is because the determining unit 150 determines the validity of the first inspection from the undetected vulnerability that is the vulnerability detected in the result of the second inspection and not detected in the result of the first inspection. This is because the output unit 160 outputs the determination result of validity. Accordingly, when the second inspection is valid, whether the first inspection is valid can be known.

### <Specific Determination Method>

The determining unit 150 may determine validity of the first inspection from the number of undetected vulnerabilities.

Specifically, the determining unit 150 may determine that the first inspection is invalid when the total number of undetected vulnerabilities is equal to or more than a predetermined number, and may determine that the first inspection is valid when the total number of undetected vulnerabilities is not greater than the predetermined number. In this case, the determining unit 150 may set the number obtained by subtracting the number of vulnerabilities detected by the first inspection from the number of vulnerabilities detected by the second inspection as the number of undetected vulnerabilities. The determining unit 150 may specify the vulnerability also detected by the first inspection in the vulnerability detected by the second inspection. Then, the determining unit 150 may specify the vulnerability detected by the second inspection and not detected by the first inspection. The determining unit 150 may set the number of specified vulnerabilities detected by the second inspection and not detected by the first inspection as the number of undetected vulnerabilities.

The determining unit 150 may determine validity of the first inspection from the number of undetected vulnerabilities (i.e., the undetected vulnerability more severe than the severity indicated by the predetermined severity) in which severity is higher than a predetermined severity. Specifically, for example, in a case where the number of vulnerabilities in which severity is higher than a predetermined severity detected in the second inspection is smaller than the number of vulnerabilities of the same severity detected in the first inspection, the determining unit 150 may determine that the first inspection is invalid. Specifically, for example, in a case where the number of vulnerabilities in which severity is higher than a predetermined severity detected in the second inspection is smaller than the number of vulnerabilities of the same severity detected in the first inspection, the determining unit 150 may determine that the first inspection is valid. The determining unit 150 may determine whether all the vulnerabilities in which severity is higher than the predetermined severity detected in the second inspection have been detected also in the first inspection. In a case where all the vulnerabilities in which severity is higher than the predetermined severity detected in the second inspection have been detected also in the first inspection, the determining unit 150 may determine that the first inspection is valid. In a case where at least one or more of the vulnerabilities in which severity is higher than the predetermined severity detected in the second inspection are not detected in the first inspection, the determining unit 150 may determine that the first inspection is invalid.

The determining unit 150 may determine validity of the first inspection from the number of undetected vulnerabilities for each severity. In this case, the determining unit 150 may calculate, for each severity, a product of a coefficient corresponding to the severity and the number of vulnerabilities detected by the second inspection and not detected by the first inspection, and set a sum of the calculated products as a score. Then, in a case where the score is smaller than a predetermined score, the determining unit 150 may determine that the first inspection is valid. Then, in a case where the score is equal to or more than the predetermined score, the determining unit 150 may determine that the first inspection is invalid. In this case, in a case where at least one or more of the vulnerabilities in which severity is higher than a predetermined severity detected in the second inspection and not detected in the first inspection, the coefficient corresponding to the severity and the predetermined score may be set such that the score is equal to or more than the predetermined score.

The determination method is not limited to the example described above.

### Second Example Embodiment

Next, a second example embodiment of the present disclosure will be described in detail with reference to the drawings.

### <Configuration>

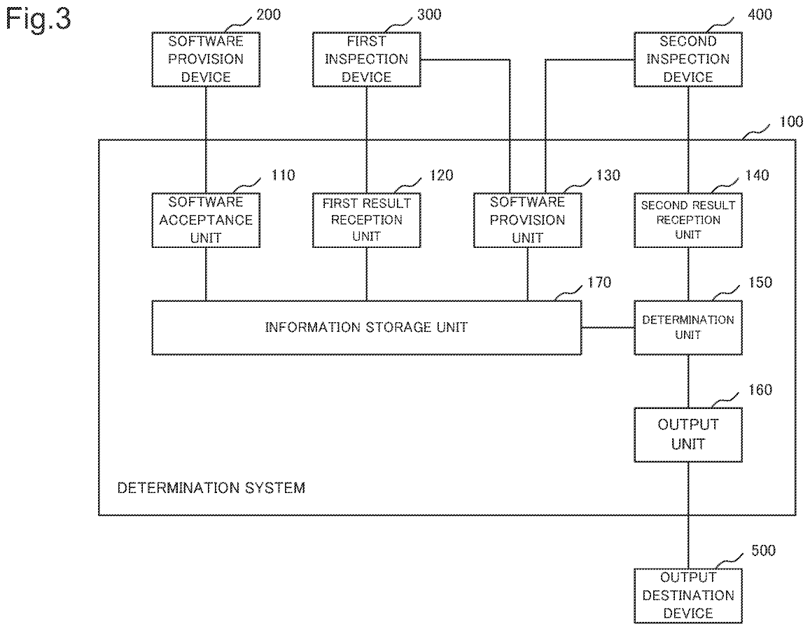

FIG. 3 is a block diagram illustrating an example of a configuration of a determination system according to a second example embodiment of the present disclosure. In the example illustrated in FIG. 3, the determination system 100 includes a software acceptance unit 110, a first result reception unit 120, a software provision unit 130, a second result reception unit 140, a determining unit 150, and an output unit 160. The determination system 100 is communicably connected to each of a software provision device 200, a first inspection device 300, a second inspection device 400, and the output destination device 500.

### <Software Provision Device 200>

The software provision device 200 provides the target software and the authenticity information of the target software to the software acceptance unit 110 of the determination system 100. The software provision device 200 is an information processing device managed by a provider of the target software. The provided target software is data necessary for installing the target software. The target software may be provided, for example, in the form of one file. The authenticity information of the target software is data that proves that the target software has been provided by a provider of the target software and has not been tampered. The authenticity information of the target software may be, for example, data generated by encrypting a hash value of a file of the target software using a private key of a provider of the target software.

### <First Inspection Device 300>

The first inspection device 300 receives the target software and the authenticity information of the target software from the software provision unit 130 of the determination system 100. The first inspection device 300 is, for example, a device that performs the first inspection described above. The first inspection device 300 is, for example, an information processing device managed by an inspection agency (in the following description, the first inspection agency) that performs the first inspection. The first inspection device 300 confirms the authenticity of the target software by using the received authenticity information. In other words, the first inspection device 300 confirms that the target software received from the software provision unit 130 has been provided from the provider of the target software and has not been tampered by using the received authenticity information. In a case where the authenticity information is data generated by encrypting the hash value of the file of the target software using the private key of the provider of the target software, the first inspection device 300 acquires the public key of the provider of the target software. Then, the first inspection device 300 confirms the authenticity of the target software by using the received authenticity information and the acquired public key of the provider of the target software. The method of acquiring the public key of the provider of the target software and the method of confirming the authenticity of the target software using the received authenticity information and the acquired public key of the provider of the target software may be existing methods. In a case where the authenticity of the target software is not confirmed, the first inspection device 300 may not perform the first inspection of the target software.

The first inspection device 300 performs a first inspection that is an inspection for vulnerability of the target software for which authenticity has been confirmed. The first inspection device 300 generates data (in the description of the present disclosure, it is also simply described as a result of the first inspection) representing the result of the first inspection and an electronic signature of the data representing the result of the first inspection. The first inspection device 300 transmits the result of the first inspection and the electronic signature of the result of the first inspection to the first result reception unit 120 of the determination system 100.

### <Second Inspection Device 400>

The second inspection device 400 receives the target software and the authenticity information of the target software from the software provision unit 130 of the determination system 100. The second inspection device 400 is, for example, a device that performs the first inspection described above. The second inspection device 400 is, for example, an information processing device managed by an inspection agency (in the following description, the first inspection agency) that performs the second inspection. The second inspection device 400 confirms the authenticity of the target software by using the received authenticity information. In other words, the second inspection device 400 confirms that the target software received from the software provision unit 130 has been provided from the provider of the target software and has not been tampered by using the received authenticity information. In a case where the authenticity information is data generated by encrypting the hash value of the file of the target software using the private key of the provider of the target software, the second inspection device 400 acquires the public key of the provider of the target software. Then, the second inspection device 400 confirms the authenticity of the target software by using the received authenticity information and the acquired public key of the provider of the target software. The method of acquiring the public key of the provider of the target software and the method of confirming the authenticity of the target software using the received authenticity information and the acquired public key of the provider of the target software may be existing methods. In a case where the authenticity of the target software is not confirmed, the second inspection device 400 may not perform the second inspection of the target software.

The second inspection device 400 performs a second inspection that is an inspection for vulnerability of the target software for which authenticity has been confirmed. The second inspection device 400 generates data (in the description of the present disclosure, it is also simply described as a result of the second inspection) representing the result of the second inspection and an electronic signature of the data representing the result of the second inspection. The second inspection device 400 transmits the result of the second inspection and the electronic signature of the result of the second inspection to the second result reception unit 140 of the determination system 100.

### <Output Destination Device 500>

The output destination device 500 receives the determination result of the validity of the first inspection from the output unit 160 of the determination system 100. The output destination device 500 may further receive, from the output unit 160 of the determination system 100, information of the undetected vulnerability, that is the vulnerability not detected by the first inspection but detected by the second inspection. The output destination device 500 may receive the information on the vulnerability detected by the first inspection and the information on the vulnerability detected by the second inspection from the output unit 160 of the determination system 100.

The output destination device 500 is, for example, a display or an information processing device including a display. The output destination device 500 may display the received information. The output destination device 500 may store the received information.

### <Software Acceptance Unit 110>

The software acceptance unit 110 accepts the target software and the authenticity information of the target software from the software provision device 200. The software acceptance unit 110 stores the target software and the authenticity information of the target software from the software provision device 200 in the information storage unit 170.

### <Software Provision Unit 130>

The software provision unit 130 provides (in other words, transmits) the target software and the authenticity information of the target software stored in the information storage unit 170 to the first inspection device 300. The software provision unit 130 provides (in other words, transmits) the target software and the authenticity information of the target software stored in the information storage unit 170 to the second inspection device 400.

### <First Result Reception Unit 120>

The first result reception unit 120 receives the result of the first inspection and the electronic signature of the result of the first inspection from the first inspection device 300. The first result reception unit 120 stores the result of the first inspection and the electronic signature of the result of the first inspection received from the first inspection device 300 in the information storage unit 170.

### <Information Storage Unit 170>

The information storage unit 170 stores the target software and the authenticity information of the target software stored by the software acceptance unit 110. The information storage unit 170 may store the target software and the authenticity information of the target software in such a way that the temporarily stored target software and the authenticity information of the target software cannot be changed. Specifically, for example, the information storage unit 170 may reject a request for rewrite, a request for deletion, and a request for overwrite of the stored target software and the authenticity information of the target software. In a case where the target software and the authenticity information thereof are repeatedly stored, the information storage unit 170 may separately store the newly stored target software and the authenticity information thereof while holding the already stored target software and the authenticity information thereof.

The information storage unit 170 further stores the result of the first inspection and the electronic signature of the result of the first inspection stored by the first result reception unit 120. The information storage unit 170 may store the result of the first inspection and the electronic signature of the result of the first inspection in such a way that the temporarily stored result of the first inspection and the electronic signature of the result of the first inspection cannot be changed. Specifically, for example, the information storage unit 170 may reject a request for rewrite, a request for deletion, and a request for overwrite of the stored result of the first inspection and the electronic signature of the result of the first inspection. In a case where the result of the first inspection and the electronic signature of the result of the first inspection are repeatedly stored, the information storage unit 170 may separately store the newly stored result of the first inspection and the electronic signature of the result of the first inspection while holding the already stored result of the first inspection and the electronic signature of the result of the first inspection

The information storage unit 170 further stores the result of the second inspection and the electronic signature of the result of the second inspection stored by the second result reception unit 140. The information storage unit 170 may store the result of the second inspection and the electronic signature of the result of the second inspection in such a way that the temporarily stored result of the second inspection and the electronic signature of the result of the second inspection cannot be changed. Specifically, for example, the information storage unit 170 may reject a request for rewrite, a request for deletion, and a request for overwrite of the stored result of the second inspection and the electronic signature of the result of the second inspection. In a case where the result of the second inspection and the electronic signature of the result of the second inspection are repeatedly stored, the information storage unit 170 may separately store the newly stored result of the second inspection and the electronic signature of the result of the second inspection while holding the already stored result of the second inspection and the electronic signature of the result of the second inspection.

The determination system 100 is controlled such that the information stored in the information storage unit 170 cannot be rewritten or deleted although the information can be additionally written in the information storage unit 170. Specifically, for example, the software acceptance unit 110 may be configured not to change, overwrite, or delete the target software and the authenticity information of the target software stored in the information storage unit 170. The first result reception unit 120 may be configured not to change, overwrite, or delete the result of the first inspection stored in the information storage unit 170. The second result reception unit 140 may be configured not to change, overwrite, or delete the result of the second inspection stored in the information storage unit 170. The information storage unit 170 may be configured not to accept a command to rewrite information already stored in the information storage unit 170, a command to overwrite information already stored in the information storage unit 170, a command to delete information already stored in the information storage unit 170, and the like.

### <Second Result Reception Unit 140>

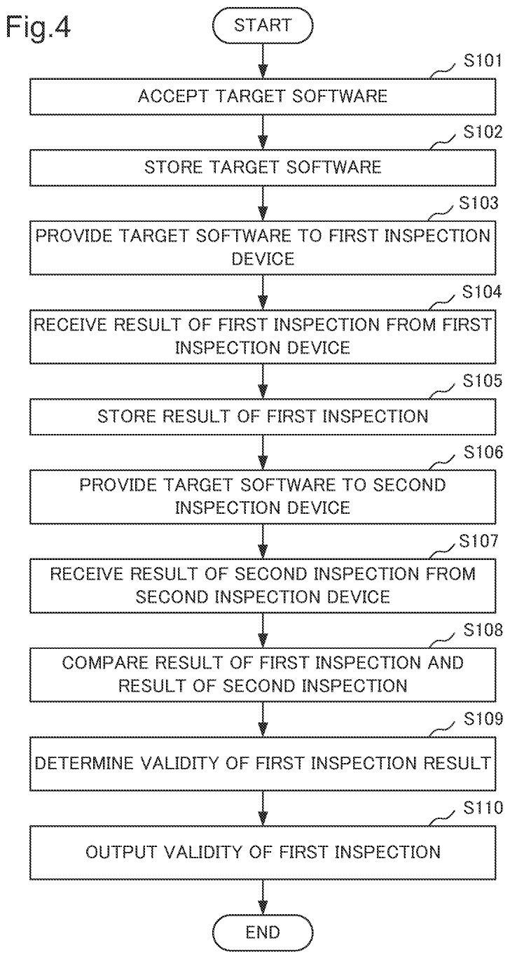

The second result reception unit 140 receives the result of the second inspection and the electronic signature of the result of the second inspection from the second inspection device 400. The second result reception unit 140 sends the result of the second inspection and the electronic signature of the result of the second inspection received from the second inspection device 400 to the determining unit 150. In the example illustrated in FIG. 4, a line connecting the second result reception unit 140 and the information storage unit 170 is omitted for simplicity, but the second result reception unit 140 may store the result of the second inspection and the electronic signature of the result of the second inspection received from the second inspection device 400 in the information storage unit 170.

### <Determining Unit 150>

The determining unit 150 reads the result of the first inspection and the electronic signature of the result of the first inspection from the information storage unit 170. The determining unit 150 uses the read electronic signature of the result of the first inspection to confirm that the result of the first inspection has been generated by the first inspection agency and has not been tampered. In a case where the electronic signature of the result of the first inspection is data generated by encrypting the hash value of the result of the first inspection with the private key of the first inspection agency, the determining unit 150 acquires the public key of the first inspection agency. The determining unit 150 then confirms that the result of the first inspection has been generated by the first inspection agency and has not been tampered through an existing method using the read electronic signature of the result of the first inspection and the acquired public key of the first inspection agency.

The determining unit 150 receives the result of the second inspection and the electronic signature of the result of the second inspection from the second result reception unit 140. In a case where the result of the second inspection and the electronic signature of the result of the second inspection are stored in the information storage unit 170, the determining unit 150 may read the result of the second inspection and the electronic signature of the result of the second inspection from the information storage unit 170. The determining unit 150 uses the read electronic signature of the result of the second inspection to confirm that the result of the second inspection has been generated by the second inspection agency and has not been tampered. In a case where the electronic signature of the result of the second inspection is data generated by encrypting the hash value of the result of the second inspection with the private key of the second inspection agency, the determining unit 150 acquires the public key of the second inspection agency. The determining unit 150 then confirms that the result of the second inspection has been generated by the second inspection agency and has not been tampered through an existing method using the read electronic signature of the result of the second inspection and the acquired public key of the second inspection agency.

In a case where it is confirmed that the result of the first inspection has been generated by the first inspection agency and has not been tampered and that the result of the second inspection has been generated by the second inspection agency and has not been tampered, the determining unit 150 determines validity of the first inspection from the undetected vulnerability that is the vulnerability detected in the result of the second inspection and not detected in the result of the first inspection. The method of determining the validity of the first inspection of the present example embodiment may be the same as the method of determining the validity of the first inspection of the first example embodiment.

The determining unit 150 sends the determination result of the validity of the first inspection to the output unit 160.

In the process of determining the validity of the first inspection, the determining unit 150 specifies the vulnerability information detected by the first inspection and the vulnerability information detected by the second inspection. The determining unit 150 may send the vulnerability information detected by the first inspection and the vulnerability information detected by the second inspection to the output unit 160.

In the process of determining the validity of the first inspection, the determining unit 150 specifies an undetected vulnerability that is a vulnerability not detected by the first inspection but detected by the second inspection. The determining unit 150 may send information on the undetected vulnerability to the output unit 160.

### <Output Unit 160>

The output unit 160 receives the determination result of the validity of the first inspection from the determining unit 150. In this case, the output unit 160 outputs the determination result of the validity of the first inspection received from the determining unit 150 to the output destination device 500.

The output unit 160 may receive, from the determining unit 150, information of an undetected vulnerability that is a vulnerability not detected by the first inspection but detected by the second inspection. In this case, the output unit 160 outputs the information on the undetected vulnerability received from the determining unit 150 to the output destination device 500.

The output unit 160 may receive the information on the vulnerability detected by the first inspection and the information on the vulnerability detected by the second inspection from the determining unit 150. In this case, the output unit 160 outputs the information on the vulnerability detected by the first inspection and the information on the vulnerability detected by the second inspection, that are received from the determining unit 150, to the output destination device 500, for example, in a format capable of comparing both pieces of information.

### <Operation>

FIG. 4 is a block diagram illustrating an example of an operation of the determination system according to the second example embodiment of the present disclosure.

In the example illustrated in FIG. 4, first, the software acceptance unit 110 accepts the target software from the software provision device 200 (step S101). In step S101, the software acceptance unit 110 may accept the target software and the authenticity information of the target software. The software acceptance unit 110 stores the accepted target software and the authenticity information of the target software in the information storage unit 170. The information storage unit 170 stores the target software (step S102). Specifically, the information storage unit 170 stores the target software and the authenticity information of the target software stored by the software acceptance unit 110.

Next, the software provision unit 130 provides the target software to the first inspection device 300 (step S103). Specifically, the software provision unit 130 reads the target software and the authenticity information of the target software from the information storage unit 170, and provides the read target software and the authenticity information of the target software to the first inspection device 300.

The first result reception unit 120 receives the result of the first inspection of the target software from the first inspection device 300 (step S104). In step S104, the first result reception unit 120 receives the result of the first inspection of the target software and the electronic signature of the result of the first inspection of the target software from the first inspection device 300. Then, the first result reception unit 120 stores the received result of the first inspection of the target software and the electronic signature of the result of the first inspection of the target software in the information storage unit 170. The information storage unit 170 stores the result of the first inspection of the target software (specifically, the result of the first inspection of the target software and the electronic signature of the result of the first inspection of the target software) stored by the first result reception unit 120 (step S105).

Next, the software provision unit 130 provides the target software to the second inspection device 400 (step S106). In step S106, the software provision unit 130 reads the target software and the authenticity information of the target software from the information storage unit 170, and provides the read target software and the authenticity information of the target software to the second inspection device 400.

The second result reception unit 140 receives the result of the second inspection of the target software from the second inspection device 400 (step S107). In step S107, the second result reception unit 140 receives the result of the second inspection of the target software and the electronic signature of the result of the second inspection of the target software from the second inspection device 400. The second result reception unit 140 sends the received result of the second inspection of the target software and the electronic signature of the result of the second inspection of the target software to the determining unit 150. The second result reception unit 140 may further store the received result of the second inspection of the target software and the electronic signature of the result of the second inspection of the target software in the information storage unit 170.

The determining unit 150 reads the result of the first inspection of the target software and the electronic signature of the result of the first inspection of the target software from the information storage unit 170. The determining unit 150 further receives the result of the second inspection of the target software and the electronic signature of the result of the second inspection of the target software from the second result reception unit 140. The determining unit 150 may read the result of the second inspection of the target software and the electronic signature of the result of the second inspection of the target software from the information storage unit 170.

The determining unit 150 compares the result of the first inspection with the result of the second inspection (step S108). Then, the determining unit 150 determines validity of the first inspection (step S109). The determining unit 150 sends the determination result of the validity of the first inspection to the output unit 160.

Then, the output unit 160 outputs the determination result of the validity of the first inspection (step S110).

### Effects

The present example embodiment has the same effect as that of the first example embodiment. The reason is the same as the reason why the effect of the first example embodiment occurs.

### Other Example Embodiments

The determination system 10 of the first example embodiment and the determination system 100 of the second example embodiment can be achieved by a computer including a processor that executes a program loaded in a memory. The determination system 10 and the determination system 100 can also be achieved by dedicated hardware. The determination system 10 and the determination system 100 can also be achieved by a combination of the computer described above and the dedicated hardware.

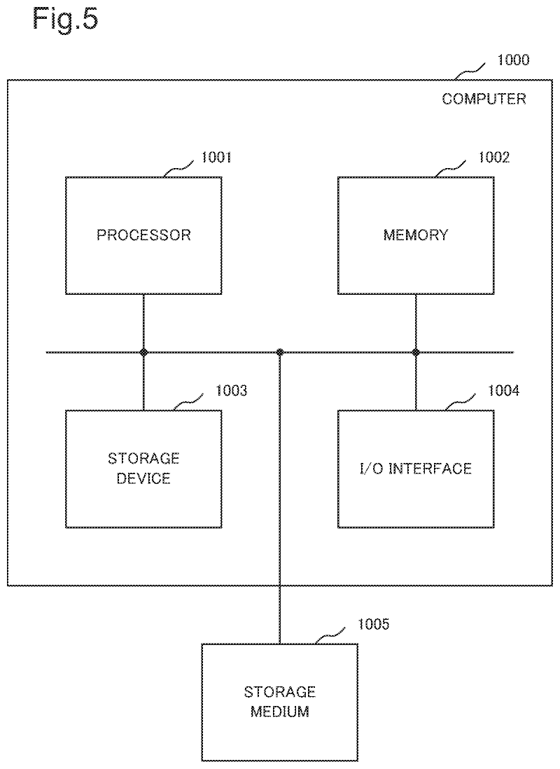

FIG. 5 is a diagram illustrating an example of a hardware configuration of a computer 1000 that can achieve the determination system according to the example embodiment of the present disclosure. In the example illustrated in FIG. 5, the computer 1000 includes a processor 1001, a memory 1002, a storage device 1003, and an input/output (I/O) interface 1004. In addition, the computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and to the memory 1002 and the storage device 1003. The processor 1001 can access, for example, the software provision device 200, the first inspection device 300, the second inspection device 400, and the output destination device 500 via the I/O interface 1004. The processor 1001 can access the storage medium 1005. The storage medium 1005 stores a program that causes the computer 1000 to operate as the determination system according to the example embodiment of the present disclosure.

The processor 1001 loads a program, that is stored in the storage medium 1005 and causes the computer 1000 to operate as the determination system according to the example embodiment of the present disclosure, into the memory 1002. Then, when the processor 1001 executes the program loaded in the memory 1002, the computer 1000 operates as the determination system according to the example embodiment of the present disclosure.

The software acceptance unit 110, the first result reception unit 120, the software provision unit 130, the second result reception unit 140, the determining unit 150, and the output unit 160 can be achieved by, for example, the processor 1001 that executes a program loaded in the memory 1002. The information storage unit 170 can be achieved by the memory 1002 included in the computer 1000 or the storage device 1003 such as a hard disk device. Some or all of the software acceptance unit 110, the first result reception unit 120, the software provision unit 130, the second result reception unit 140, the determining unit 150, the output unit 160, and the information storage unit 170 can be achieved by a dedicated circuit that achieves the function of each unit.

Some or all of the above example embodiments may be described as the following supplementary notes, but are not limited to the following.

### (Supplementary Note 1)

A determination system including:

a first result reception unit that receives a first inspection result that is a result of a first inspection of vulnerability of target software;

a second result reception unit that receives a second inspection result that is a result of a second inspection of vulnerability of the target software;

a determining unit that determines validity of the first inspection from undetected vulnerability that is vulnerability detected in the result of the second inspection and not detected in the result of the first inspection; and

an output unit that outputs the result of the determination of the validity.

### (Supplementary Note 2)

The determination system according to supplementary note 1, wherein the determining unit determines the validity from number of the undetected vulnerabilities.

### (Supplementary Note 3)

The determination system according to supplementary note 2, wherein the determining unit determines the validity from the number of the undetected vulnerabilities in which severity degree representing severity is higher than a predetermined severity degree.

### (Supplementary Note 4)

The determination system according to supplementary note 3, wherein the determining unit determines the validity from the number for each severity degree of the undetected vulnerabilities.

### (Supplementary Note 5)

The determination system according to any one of supplementary notes 1 to 4, wherein the determining unit determines the validity from the number for each type of the undetected vulnerabilities.

### (Supplementary Note 6)

The determination system according to any one of supplementary notes 1 to 5, further comprising:

an information storage unit that stores the target software and authenticity information of the target software;

a software provision unit that provides the target software and the authenticity information to a first inspection device that performs the first inspection and a second inspection device that performs the second inspection;

a first result reception unit that receives a result of the first inspection and an electronic signature of the result of the first inspection from the first inspection device, and stores the received result of the first inspection and the electronic signature of the result of the first inspection in the information storage unit;

a second result reception unit that receives a result of the second inspection and an electronic signature of the result of the second inspection from the second inspection device; and

an output unit that outputs a result of determination of the validity degree, wherein

the information storage unit stores the first inspection result in such a way that the stored first inspection result cannot be changed, and the output unit further outputs information on the undetected vulnerability.

### (Supplementary Note 7)

A determination method comprising:

receiving a first inspection result that is a result of a first inspection for vulnerability of target software;

receiving a second inspection result that is a result of a second inspection for vulnerability of the target software;

determining validity of the first inspection from an undetected vulnerability that is a vulnerability detected in a result of the second inspection and not detected in a result of the first inspection; and

outputting a result of determination of the validity.

### (Supplementary Note 8)

The determination method according to supplementary note 7, further comprising determining the validity from number of the undetected vulnerabilities.

### (Supplementary Note 9)

The determination method according to supplementary note 8, further comprising determining the validity from the number of the undetected vulnerabilities in which severity degree representing severity is higher than a predetermined severity degree.

### (Supplementary Note 10)

The determination method according to supplementary note 9, further comprising determining the validity from the number for each severity degree of the undetected vulnerabilities.

### (Supplementary Note 11)

The determination method according to any one of supplementary notes 7 to 10, further comprising determining the validity from the number for each type of the undetected vulnerabilities.

### (Supplementary Note 12)

The determination method according to any one of supplementary notes 7 to 11, further comprising:

storing the target software and authenticity information of the target software in an information storage unit;

providing the target software and the authenticity information to a first inspection device that performs the first inspection and a second inspection device that performs the second inspection;

receiving a result of the first inspection and an electronic signature of the result of the first inspection from the first inspection device, and storing the received result of the first inspection and the electronic signature of the result of the first inspection in the information storage unit;

receiving a result of the second inspection and an electronic signature of the result of the second inspection from the second inspection device;

outputting a result of determination of the validity;

storing the first inspection result in such a way that the stored first inspection result cannot be changed; and

further outputting information on the undetected vulnerability.

### (Supplementary Note 13)

A storage medium storing a program for causing a computer to execute:

first result reception processing of receiving a first inspection result that is the result of a first inspection of the vulnerability of target software;

second result reception processing of receiving a second inspection result that is the result of a second inspection of the vulnerability of the target software;

determination processing of determining the validity of the first inspection from undetected vulnerability that is the vulnerability detected in the result of the second inspection and not detected in the result of the first inspection; and

output processing of outputting the result of the determination of the validity.

### (Supplementary Note 14)

The storage medium according to supplementary note 13, wherein the determination processing determines the validity from number of the undetected vulnerabilities.

### (Supplementary Note 15)

The storage medium according to supplementary note 14, wherein the determination processing determines the validity from the number of the undetected vulnerabilities in which severity degree representing severity is higher than a predetermined severity degree.

### (Supplementary Note 16)

The storage medium according to supplementary note 15, wherein the determination processing determines the validity from the number for each severity degree of the undetected vulnerabilities.

### (Supplementary Note 17)

The storage medium according to any one of supplementary notes 13 to 16, wherein the determination processing determines the validity from the number for each type of the undetected vulnerabilities.

### (Supplementary Note 18)

The storage medium according to any one of supplementary notes 13 to 17, further causing a computer to execute:

information storage processing of storing the target software and authenticity information of the target software in an information storage unit;

software provision processing of providing the target software and the authenticity information to a first inspection device that performs the first inspection and a second inspection device that performs the second inspection;

first result reception processing of receiving a result of the first inspection and an electronic signature of the result of the first inspection from the first inspection device, and storing the received result of the first inspection and the electronic signature of the result of the first inspection in an information storage unit;

second result reception processing of receiving a result of the second inspection and an electronic signature of the result of the second inspection from the second inspection device; and

output processing of outputting a result of determination of the validity, wherein

the information storage processing stores the first inspection result in such a way that the stored first inspection result cannot be changed, and

the output processing further outputs information on the undetected vulnerability.

Although the present disclosure has been described with reference to the example embodiments, the present disclosure is not limited to these example embodiments. Various changes that can be understood by those skilled in the art can be made to the configuration and details of the present disclosure within the scope of the present disclosure.

### REFERENCE SIGNS LIST

10 Determination system
100 Determination system
110 Software acceptance unit
120 First result reception unit
130 Software provision unit
140 Second result reception unit
150 Determining unit
160 Output unit
170 Information storage unit
200 Software provision device
300 First inspection device
400 Second inspection device
500 Output destination device
1000 Computer
1001 Processor
1002 Memory
1003 Recording device
1004 I/O interface
1005 Recording medium

What is claimed is:

1. A determination system comprising:
at least one memory storing a set of instructions; and
at least one processor configured to execute the set of instructions to:
receive a first inspection result that is a result of a first inspection of vulnerability of target software;
receive a second inspection result that is a result of a second inspection of vulnerability of the target software;
determine validity of the first inspection from undetected vulnerability that is vulnerability detected in the result of the second inspection and not detected in the result of the first inspection; and
output a result of determination of the validity.

2. The determination system according to claim 1, wherein
the at least one processor is further configured to execute the instructions to determine the validity from a count of the undetected vulnerability.

3. The determination system according to claim 2, wherein
the at least one processor is further configured to execute the instructions to determine the validity from the count of the undetected vulnerability whose severity degree representing severity is higher than a predetermined severity degree.

4. The determination system according to claim 3, wherein
the at least one processor is further configured to execute the instructions to determine the validity from the count for each severity degree of the undetected vulnerability.

5. The determination system according to claim 1, wherein
the at least one processor is further configured to execute the instructions to determine the validity from the count for each type of the undetected vulnerability.

6. The determination system according to claim 1, further comprising
information storage that stores the target software and authenticity information of the target software, wherein
the at least one processor is further configured to execute the instructions to:
provide the target software and the authenticity information to a first inspection device that performs the first inspection and a second inspection device that performs the second inspection;
receive the result of the first inspection and an electronic signature of the result of the first inspection from the first inspection device, and storing the received result of the first inspection and the electronic signature of the result of the first inspection in the information storage;
receive the result of the second inspection and an electronic signature of the result of the second inspection from the second inspection device; and
output the result of determination of the validity, wherein
the information storage stores the first inspection result in such a way that the stored first inspection result is not able to be changed, and
the at least one processor is further configured to execute the instructions to output information on the undetected vulnerability.

7. A determination method comprising:
receiving a first inspection result that is a result of a first inspection for vulnerability of target software;
receiving a second inspection result that is a result of a second inspection for vulnerability of the target software;
determining validity of the first inspection from an undetected vulnerability that is a vulnerability detected in a result of the second inspection and not detected in a result of the first inspection; and
outputting a result of determination of the validity.

8. The determination method according to claim 7, further comprising
determining the validity from a count of the undetected vulnerability.

9. The determination method according to claim 8, further comprising
determining the validity from the count of the undetected vulnerability whose severity degree representing severity is higher than a predetermined severity degree.

10. The determination method according to claim 9, further comprising
determining the validity from the count for each severity degree of the undetected vulnerability.

11. The determination method according to claim 7, further comprising
determining the validity from the count for each type of the undetected vulnerability.

12. The determination method according to claim 7, further comprising:
storing the target software and authenticity information of the target software in information storage;
providing the target software and the authenticity information to a first inspection device that performs the first inspection and a second inspection device that performs the second inspection;
receiving the result of the first inspection and an electronic signature of the result of the first inspection from the first inspection device, and storing the received result of the first inspection and the electronic signature of the result of the first inspection in the information storage;
receiving the result of the second inspection and an electronic signature of the result of the second inspection from the second inspection device;
outputting the result of determination of the validity;
storing the first inspection result in such a way that the stored first inspection result is not able to be changed; and
further outputting information on the undetected vulnerability.

13. A non-transitory computer readable storage medium storing a program for causing a computer to execute:
first result reception processing of receiving a first inspection result that is a result of a first inspection of vulnerability of target software;
second result reception processing of receiving a second inspection result that is a result of a second inspection of the vulnerability of the target software;
determination processing of determining a validity of the first inspection from undetected vulnerability that is the vulnerability detected in the result of the second inspection and not detected in the result of the first inspection; and
output processing of outputting the result of the determination of the validity.

14. The non-transitory computer readable storage medium according to claim 13, wherein the determination processing determines the validity from a count of the undetected vulnerability.

15. The non-transitory computer readable storage medium according to claim 14, wherein
the determination processing determines the validity from the count of the undetected vulnerability whose severity degree representing severity is higher than a predetermined severity degree.

16. The non-transitory computer readable storage medium according to claim 15, wherein
the determination processing determines the validity from the count for each severity degree of the undetected vulnerability.

17. The non-transitory computer readable storage medium according to claim 13, wherein
The determination processing determines the validity from the count for each type of the undetected vulnerability.

18. The non-transitory computer readable storage medium according to claim 13, further causing a computer to execute:
information storage processing of storing the target software and authenticity information of the target software in information storage; and
software provision processing of providing the target software and the authenticity information to a first inspection device that performs the first inspection and a second inspection device that performs the second inspection, wherein
the first result reception processing receives the result of the first inspection and an electronic signature of the result of the first inspection from the first inspection device, and storing the received result of the first inspection and the electronic signature of the result of the first inspection in information storage,
the second result reception processing of receiving the result of the second inspection and an electronic signature of the result of the second inspection from the second inspection device,
the output processing of outputting the result of determination of the validity,
the information storage processing stores the first inspection result in such a way that the stored first inspection result is not able to be changed, and
the output processing further outputs information on the undetected vulnerability.
